(19) United States
(12) Patent Application Publication
(10) Pub. No.: US 2003/0088631 A1
(43) Pub. Date: May 8, 2003

(54) Onboard communications

(76) Inventors: Roy L. Hixson, Winter Springs, FL (US); Clementina M. Siders, Orlando, FL (US); Frank A. Ashton, Atlantic Beach, FL (US); David B. Wood, Palm Bay, FL (US); David S. Elliott, Rowlett, TX (US); Jack W. Burqess, Orange Park, FL (US)

Correspondence Address: Robert W. Adams, NAWCTSD 773P, 12350 RESEARCH PARKWAY, Orlando, FL, 32826-3275, US

(21) Appl. No.: 10/011,231

(22) Filed: Nov. 2, 2001

(51) Int. Cl. G06F 15/16

(52) U.S. Cl. 709/206

(57) ABSTRACT

Disclosed is an onboard, on-the-job, communication interface system that can dynamically provide information and personnel location on request, anywhere, anytime. The system can connect to an Intranet or Internet using a wireless LAN.

### BACKGROUND OF THE INVENTION

Shipboard communication is currently accomplished through numerous mechanisms and media. The standard practices of 1MC announcements, publishing of the Plan of the Day, TV announcements, hands on face to face training, and musters have been used for years and have worked well. Unfortunately, these efforts are at times uncoordinated, make little use of newer communication technologies, and can be labor and time intensive. Combine the above with the mandate for greatly reduced crew size and increased operational flexibility and it becomes obvious that coordinated, real time crew/ship communication capability that requires less time and labor is base to success of the 21^{st} century Navy. When this newer communication capability is combined with a shipboard personnel location system, the potential for increased operational flexibility is tremendous. Training is generally accomplished through the integration of training both onboard and off the ship, in the schoolhouse. Unfortunately, there may be a substantial period of lapsed time between the detailed schoolhouse training and the actual hands-on, visual reinforcement of seeing the equipment in place, onboard the ship. The lapsed time may be generally detrimental to the effectiveness of training, such that substantial, additional time is required to accomplish the actual shipboard system familiarization. Also, some ships have unique system modifications, which conflict with the schoolhouse training material, drawings, video, and photographs. The trainee may not be aware of these modifications until he arrives at the ship. Historically, the on-board training process has required instruction and assistance by knowledgeable, experienced personnel. For example, during familiarization training, the instructor walks the trainee through the systems and explains the functions of various systems. This process is often very time-consuming, frequently requiring lengthy delays in completing the necessary training. The instruction necessary for each trainee may also vary significantly because of the experience levels of the mentor and the student. With reduced shipboard manning levels and further manning reductions planned in the future, it will be important for both training systems developers and the customers to develop and use new methods to deliver training in a timely manner that meet our customer's readiness needs.

### SUMMARY OF THE INVENTION

The present invention provides a concept for a novel way to provide onboard communication using location technology and mobile computing products (both hardware and software). The present invention is an onboard, on-the-job, communication interface system that can dynamically provide information and personnel location on request, anywhere, anytime. The application can connect to the Intranet or Internet using a wireless LAN. The present invention can be invoked along with a self-directed, self-paced, standardized training/orientation system for shipboard members. Self-directed and self-paced means that the trainee will be able to use a portable computing device to determine training locations on the ship, receive appropriate Interactive Media Instruction (IMI) at the location(s) desired, and receive guidance to the next point of training until the training sequence is complete. This training can include high-level instruction such as familiarization training or more complex training such as maintenance, operational training and team training

### BRIEF DESCRIPTION OF THE DRAWINGS

FIG. 1 is a functional flow diagram of the present invention;

FIG. 2 is a system block diagram of the present invention;

FIG. 3 is a functional diagram of the software elements of the present invention; and,

FIG. 4 is a pictorial representation of a compartment map for a shipboard embodiment of the present invention.

### DESCRIPTION OF A PREFERRED EMBODIMENT

Pursuant to a preferred embodiment of the present invention, each sailor carries a portable personal communication device that leverages off the Interactive Media Instruction (IMI) subsystem hereinafter described. Each device includes a headset and boom mike for aural interaction, a keypad or voice activated controller for digital interaction and a small display that could be located on safety glasses or portable flat panel for visual interaction. This system is interactive person to person, ship to person, and person to ship. Person to person is the capability to pass human centered information on all aspects of shipboard life and warfighting. Some examples include training, operational procedures, planning, behavior expectations, and general interest items. Ship to person is the capability for shipboard systems to automatically communicate maintenance status, battle damage, and operational information. Person to ship communication is the capability for a sailor to direct and operate shipboard systems. All of these interactive communication capabilities are independent of time or location of the person(s) involved. A controller or server is required to ensure proper routing of information and to insert “smart” data into the communication program. Combining this communication capability with the location subsystem described above provides additional operational flexibility. Because the ship and/or communication system knows where each individual sailor is at all times, communication can be directed to where the greatest operational leverage can be gained. For example, an inadvertent open valve would automatically report its' condition via the ship to person capability. The communication system would route the information to the sailor(s) responsible for that valve. The sailor would inturn use the person to ship capability to direct the valve to close. Should the valve not have the ability to shut itself (maybe because of battle damage, or by design) the location system would identify the sailor that is closest to the valve and tell him/her to close it. If he/she does not know how to shut it off they can receive immediate training on how to shut it off.

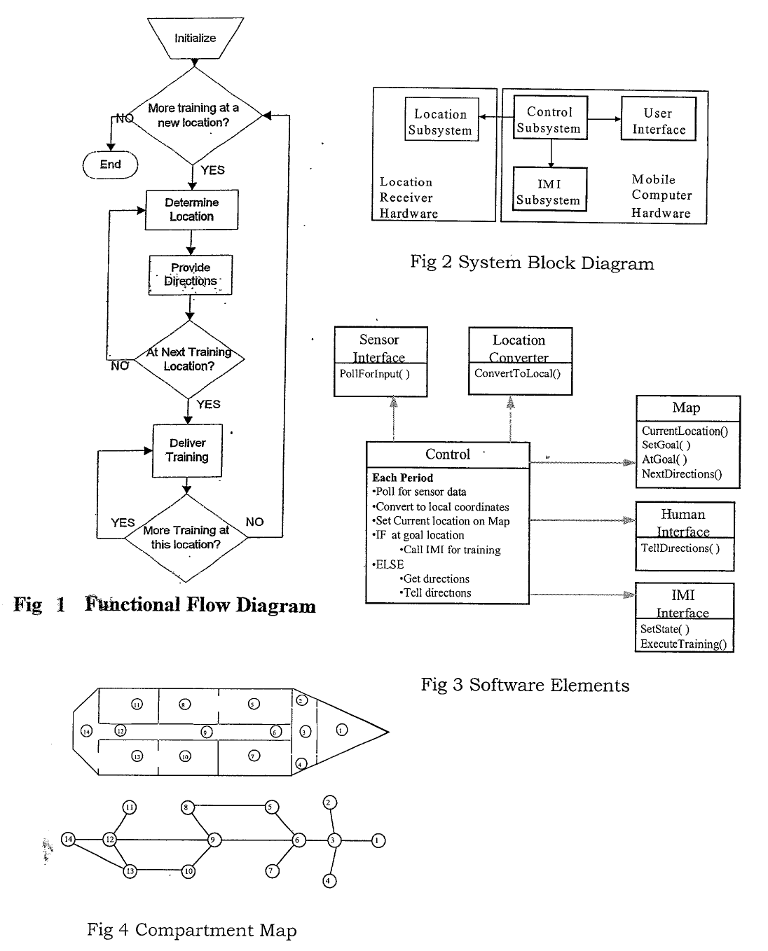

A simple functional flow diagram of the self-directed training system is provided in FIG. 1.

System Block Diagram

By use of the localization technology, the system identifies its location within the ship to define a starting reference or initialization point. It then asks if training at a new location is needed. If so, then it determines the next location, routing and appropriate direction to move to the designated training location. That question is repeated through each location node until the trainee arrives at a training node. Location nodes are physical points were the trainee has the option to change their direction. For example, a passageway intersection, or a ladder connection between decks. Upon arrival at the training node, training is delivered until complete. The cycle then repeats itself until all training is complete.

The functional flow diagram described in FIG. 1 may be realized by a system composed of three (3) subsystems: the Location Subsystem, the Control subsystem (see FIG. 2), and Interactive Media Instruction (IMI) subsystem.

Location Subsystem

The Location Subsystem provides the location of the student, and may be composed of one/some of the technologies. Knowing where the trainee is physically located on the ship is a key requirement of this training system design. The trainee is expected to have little or no awareness of the shipboard layout and the system must enable him to establish his specific location on the ship within a reasonable margin of error. Locating the individual accurately is also important so that appropriate instructions can be given by the system to direct the individual to each specific training site or node.

Some of the technologies currently being utilized in a variety of settings to accomplish the locating function include but are not limited to:

Radio Frequency (RF)

Infrared (IR)

Location Bar Coding

Global Positioning System (GPS)

Video Mapping

Fixed Audio Touring

Vision Recognition (Black/White or Color Marker Patterns)

Control Subsystem

The Control subsystem receives the trainee's location from a reading device input. It then determines if the trainee is at the designated training site, or provides directions to the student on how to proceed to the next training location.

The software architecture associated with controlling a shipboard location identification system integrated with mobile computing and interactive courseware presents no significant technical hurdles.

The software architecture is depicted in FIG. 3, and includes: elements to hide the outside interfaces (reader or sensor, IMI, Human Computer Interface (HCI)), a map element that contains a graph representation of the ship's spaces, an element to convert the reader or sensor data into map-compatible locations, and a ‘control’ element that sequences and coordinates the operation of the software.

Control Element

The control element is activated periodically (once per second) as a training session is in progress. As the notes in the Figs imply, this element will ask the Sensor for its current data. The data from the Sensor is then converted to a format suitable for input of current position on the map. The Map, which knows the student's goal position is asked if the goal has been reached. If the student is at the goal location, the IMI software is activated. If the student is not at the goal location, the map provides directions to reach goal, which are then provided to the student by the HCI.

Boundary Element

The boundary element to the Sensor hardware has allowed us to vary the type of devices used, and even to simulate the input. For the initial prototype effort, this element's PollForInput operation simply reads a test file to provide stimulus to the system.

Map Element

The map, a connected graph, consists of a set of nodes that represent the spaces, and vertices that represent the passageway between these spaces. This association is shown (overly simplified, and for a single deck) in FIG. 4.

The Shortest-Path-First algorithm has been used to traverse the graph from any location to a designated goal, however other algorithms can be implemented to achieve similar results. The map element also contains the information needed to provide directions from one location to the next.

The Human Interface outputs directions using an appropriate method for the type of training being provided. This may be a simple text string to a display (as in the prototype) or synthesized speech. In either case, changes in the Human Interface are contained in this element.

The IMI interface encapsulates the interface to a commercial authoring product tailored to fit the shipboard training and activated when the student has reach a designated location. Each training location could have its courseware encapsulated in its own executable file.

Alternatively, the courseware could be in one executable, and then a command line interface should allow parameters to be passed to indicate the portion of the courseware that should be delivered. Separate executables are the preferred approach because of the reduction in life cycle maintenance costs. However, proper file organization is essential when considering this approach.

Interactive Media Instruction (IMI) Subsystem

The IMI subsystem is configured and initiated by the Control subsystem. Interactive Multimedia Instruction (IMI) is the portion of this system that delivers the instruction and verifies the trainee's understanding once he has reached each of his training (goal) locations. Interactive Multimedia Instruction is interactive, electronically delivered training. Interactive training software dynamically reacts to the trainee's input allowing for instructional delivery that is tailored and optimized for each individual's needs.

Multimedia-capable systems can utilize text, graphics, animations, audio, and high quality video. With the addition of interactivity, trainees are able to control the presentation. They can determine the order in which topics are presented and can advance through the presentation at their own pace. Sections of the material can be repeated. The learner has an active and engaging role in the instruction. Students can practice newly acquired skills and can be tested in order to determine whether to continue with the instruction or whether to provide remedial training.

Once the trainee has reached a training location, the system initiates the execution of the site-specific Interactive Multimedia Instruction. Headphones with a boom microphone and a corded keyboard can be used to facilitate the interactivity. The interaction can require the student to respond to questions designed to test his knowledge of the training site equipment at the conclusion of the instructional phase. If the trainee does not successfully answer the test questions, remedial training is immediately instituted by the courseware.

In some cases, the trainee will remain at the training site until he has successfully completed the instruction and practice exercises (optional). The trainee also has the option to bookmark his place and return to where he exited the instruction at a later time. After the objectives at that site have been met, the IMI relinquishes control and the system directs the student to the next training location.

Advantages of the present invention primarily is focused on near instantaneous and directed communications for more efficient operation and interface between crew and hardware. The concept features the ability to immediately and automatically connect people to people or people to hardware to optimize response for normal and casualty operations with significantly reduced manpower. The netted two-way communication eliminates the delays and wasted energy locating the right person, receiving the message and providing the appropriate response or action. Tasking could be directed to specific personnel to manage of configure hardware, and the hardware would provided the netted response so the internal command structure would know immediately of the actions taken. The system could also include a smart logic, so only the appropriate personnel that have been trained and approved to manage the hardware could actually manage the hardware. The system would provide the capability to determine where all members of the crew are within the ship to coordinate emergency response, manage work schedules and support administrative mustering. Engineering spaces may no longer require any watch stations in the spaces at all. Hardware could communicate to either a person or command center when both preventive and corrective maintenance is required.

The present invention is not limited to shipboard management. It can be used in conjunction with security systems for building security or medical facilities to better manage localization and movement of critical care equipment, the operators and location of immediate need. The present invention also can be used in commercial, military or educational settings to accomplish productivity gains with fewer personnel.

There are several additional advantages for purposes of training. The overall system minimizes the need for the more experienced shipboard personnel (mentors) to provide training for new personnel. The proposed system allows each trainee to move, self-directed, at a self-paced level of training. The training is standardized so that the quality and consistency is independent of the experience level of the on-board mentors. It also provides for enhanced, interactive training with much higher levels of retention and a significant reduction in the amount of time needed to complete training.

Other alternatives to the embodiment shown, or additions to the features described above include the application of the overall system to environments not limited to shipboard training. The overall system can be used in buildings, planes, etc. Further, it can be used in the commercial, military or in an educational setting.

What is claimed is:

1. A method for communicating with at least one recipient within a preselected area of space by recipient's location, comprising the steps of:
identifying the location of a said recipient within said space;
selecting the recipient to receive said communication by recipient's location; and
communicating to said selected recipient.

2. The method of claim 1 wherein said communicating step is interactive.

3. The method of claim 1 wherein said communicating step to said recipient is instructive.
